(19) United States
(12) Patent Application Publication
(10) Pub. No.: US 2008/0307913 A1
(43) Pub. Date: Dec. 18, 2008

(54) Method for Producing a Gearbox, and Corresponding Gearbox

(76) Inventors: Hans-Juergen Oberle, Rastatt (DE); Caroline Weinman, Renton, WA (US)

Correspondence Address: MICHAEL J. STRIKER, 103 EAST NECK ROAD, HUNTINGTON, NY, 11743, US

(21) Appl. No.: 11/572,728

(22) PCT Filed: Aug. 12, 2005
(86) PCT No.: PCT/EP05/53984

§ 371 Date: Jan. 26, 2007

(30) Foreign Application Priority Data
Sep. 29, 2004 (DE) 10 2004 047 184.3

(51) Int. Cl. F16H 1/16; F16H 1/20; B23P 15/14

(52) U.S. Cl. 74/416; 29/893.1

(57) ABSTRACT

The invention relates to a gearbox (10), and to a method for producing the gearbox (10) with axial tolerance compensation, in particular for displacing movable parts in a motor vehicle, that includes a housing (12) that is composed of at least two housing parts (14, 16), a pinion (34), and a worm gear (26) that has a central axial recess (42). The inventive method includes the following production steps:
the worm gear (26) and the pinion (34) are located as separate parts on a common central axis (28) in at least one of the two housing parts (14, 16)
the two housing parts (14, 16) are joined and connected along the axis (28) such that, during axial assembly of the two housing parts (14, 16), the pinion (34) is pressed into the recess (42) of the worm gear (26) in a non-rotatable manner.

### RELATED ART

The present invention relates to a method for producing a gearbox, with which a pinion and a worm gear are supported in a housing, and a gearbox produced using this method, according to the preamble of the independent claims.

Publication WO 00/33445 makes known an electric actuator, in the case of which a gearbox is located inside a housing that includes two joinable housing shells. Via a worm located on the armature shaft, an electric motor drives a worm gear that is non-rotatably connected with a pinion. The pinion, in turn, drives a further gear stage that is operatively connected with a driven pinion. The worm gear and the pinion are integral in design, i.e., they are designed as a single gearbox component that is located on a support bolt fastened in the housing. A single-part gearbox component of this type can be made out of plastic or metal, e.g., using an injection-molding method.

A disadvantage of such a single-component design of the worm gear with the pinion is that, due to manufacturing tolerances, after it is installed in the housing, a certain amount of axial play of the worm gear-pinion unit results, or it becomes jammed inside the housing. The efficiency and service life of the gearbox are reduced as a result. If the worm gear-pinion unit—which is composed of several parts—is not joined or injection-molded exactly before it is installed in the housing, concentricity tolerances of the worm gear and the pinion also result, which can result in even more noise being produced.

### ADVANTAGES OF THE INVENTION

The inventive manufacturing procedure and the inventive gearbox with the characterizing features of the independent claims have the advantage that, by designing the worm gear and the pinion as separate components, they can be connected with each other when the housing is joined such that the production-related axial tolerances of the housing parts and the gearbox components are compensated. Axial play is effectively prevented as a result, and the pinion—which is connected with the worm gear—is also effectively prevented from becoming jammed inside the housing. As a result, the tolerance requirements for the production of the gearbox do not have to be so high. The parts can therefore be manufactured less expensively while maintaining the same level of product quality (due to axial tolerance compensation). According to the present invention, in this production method, the worm gear and the pinion are positioned, as individual parts, between the two housing parts using an axial guide. When the two housing parts are joined, the pinion is pressed axially into the recess of the worm gear until the housing is securely closed. Due to the form-fit interference connection between the pinion and the worm gear, it is therefore possible to reliably transfer the driving torque from the worm gear to the pinion.

Advantageous refinements and improvements of the features indicated in the independent claims are made possible by the measures listed in the subclaims. It is an advantage, for example, when the worm gear and the pinion are guided radially onto a support bolt that is located between the housing parts. This effectively prevents the pinion from tilting when it is pressed into the recess of the worm gear. The tolerance-insensitive connection of the worm gear with the pinion is guided radially onto the support bolt such that uniform concentricity of these gearbox components is attained, noise is reduced, and service life is extended.

When each of the two housing parts has an axial stop face against which the pinion and the worm gear bear via their end faces, axial play can be eliminated nearly entirely, and the pinion and the worm gear can be rotated simultaneously between the housing parts with minimal frictional loss. This results in a long service life and minimal noise produced by the gearbox.

To make it easier to press the pinion axially into the recesses in the worm gear, the recess includes various axial regions which are penetrated, in succession, by the end face of the pinion. In the conical transition region, the pinion is centered relative to the recess and is then pressed into the interference region using an axial installation force determined by the interference fit. As a result, the pinion is reliably fixed in position axially in the worm gear for the duration of the operating time.

To transfer torque from the worm gear to the pinion, it is particularly favorable to create a form-fit connection via the outer toothing of the pinion. To this end, the recess has a matching inner profile that has a slightly smaller radius than that of the outer toothing on the pinion. Using a form-fit interference fit of this type, the pinion is secured against axial displacement and rotation relative to the worm gear.

The selection of the ratio of the diameters of the outer toothing of the pinion and the inner toothing of the recesses determines the amount of axial force required to press in the pinion. This axial force must be applied when the two housing parts are joined axially in order to attain a reliable interference fit. Depending on the application of the gearbox, the press fit is selected such that the axial forces that occur during operation do not exceed the axial assembly force required for installation.

With the inventive gearbox that is produced using the inventive method, the pinion and the worm gear are connected with each other using the axial press-in force that is applied to press the outer toothing into the recess when the housing is assembled, without the need for an additional assembly step. The pinion-worm gear unit has the same mechanical stability as a single-part gearbox component, but with the additional advantage that the axial production and assembly tolerances are compensated.

The radial support of the pinion that is connected with the worm gear according to the present invention can be realized via a support bolt in the housing or via a bearing journal that is integrally formed on the pinion and/or worm gear.

When the pinion and/or worm gear are supported using a support bolt that is secured in a housing part, e.g., in a non-rotatable manner, the pinion and/or the worm gear have an axial through-bore via which they are supported directly radially on the support bolt. In the case of the worm gear, the through-bore is integrally formed at the base of the recess, so that, when the pinion is pressed into the recess, the two components are oriented radially relative to each other by the support bolt.

By forming axial bearing journals integrally on the worm gear and/or the pinion, they can be supported directly radially in both housing parts, thereby eliminating the need for the support bolt. The radial centering that occurs when the pinion is pressed into the worm gear takes place via the shape of the recess.

If the recess has, e.g., a conical transition region with a certain axial expansion, when the pinion is inserted into the recess, the pinion is centered exactly and is then pressed into an interference region of the recess, the axial expansion of which is selected such that a reliable press fit is created.

To ensure that the axial tolerances between the pinion-worm gear unit and the housing are fully compensated, the recess is designed to be so deep that its base surface has a certain clearance from the end face of the pinion after the housing parts have been fully joined.

### DRAWING

Various exemplary embodiments of an inventive gearbox and its production method are presented in the drawing and are described in greater detail in the description below.

FIG. 1 shows a schematic illustration of the assembly of the gearbox,

FIG. 2 shows a fully-assembled gearbox according to the embodiment in FIG. 1, and

FIG. 3 shows a further exemplary embodiment of a fully-assembled gearbox.

### DESCRIPTION OF THE EXEMPLARY EMBODIMENTS

FIG. 1 shows a gearbox 10 with a housing 12, which includes at least a first housing part 14 and a second housing part 16. First housing part 14 is designed, e.g., as a pot-shaped housing shell 14, which can be closed with second housing part 16 that is designed as a cover 17. A support bolt 20 is located in housing 12, which is fastened, e.g., non-rotatably, to first housing part 14, and is injection-molded therein in particular. Second housing part 16 includes a receptacle 22 into which support bolt 20 is inserted when housing parts 14 and 16 are joined in axial direction 24. To assemble gearbox 10, a worm gear 26 is inserted into first housing part 14 along an axis 28 so that its worm gear toothing 30 meshes with a driving worm 32. A pinion 34, which is designed as a separate component, is inserted into first housing part 14 along same axis 28. Pinion 34 includes an outer toothing 36 and an axial end face 38 that bears loosely against an inner profile 40 of an axial recess 42 of worm gear 26 before the two housing parts 14 and 16 are joined. To assemble gearbox 10, second housing part 16 is slid along axis 28 toward first housing part 14. Pinion 34 is pressed in axial direction 24 into recess 42 of worm gear 26. Assembly force 44 required to do this results from the specific design of the interference fit between pinion 34 and recess 42. Housing parts 16 and 14 are pressed against each other until they touch each other at their connecting points 46. Housing parts 14 and 16 are then joined, with connecting elements 48, i.e., screws 50, in corresponding connecting receptacles 52, in order to securely close housing 12. In the exemplary embodiment, pinion 34 and worm gear 26 have an axial through-bore 18 that is penetrated by support bolt 20. Pinion 34 and the worm gear therefore bear radially directly against support bolt 20 for radial support, without, e.g., another component being located between worm gear 26 and support bolt 20. Support bolt 20 is inserted into receptacle 22 of second housing part 16 for radial support. To ensure that pinion 34 can be pressed into recess 42 exactly, recess 42 has a first radial clearance-fitting region 54 with axial dimension 56, against which a conical transition region 58 abuts with an axial length 60. In addition, recess 42 includes an interference region 62 with an axial length 64 that forms actual interference fit 66 with pinion 34. When pinion 34 is inserted into recess 42 when housing parts 14 and 16 are joined, end face 38 initially bears loosely against inner profile 40, e.g., against conical transition region 58. In this state, housing parts 14 and 16 have clearance 68 between them that is less than an air gap 70 in receptacle 22 between support bolt 20 and housing part 16. In this state, gap 68 between housing parts 14 and 16 is also less than the sum of axial expansions 60 and 64 of transition region 58 and interference region 62. This ensures that pinion 34 and worm gear 26 do not become jammed in housing 12 when housing parts 14 and 16 are joined. Gap 68 is greater than axial length 60 of transition region 58, so that pinion 34 is pressed far enough into interference region 62.

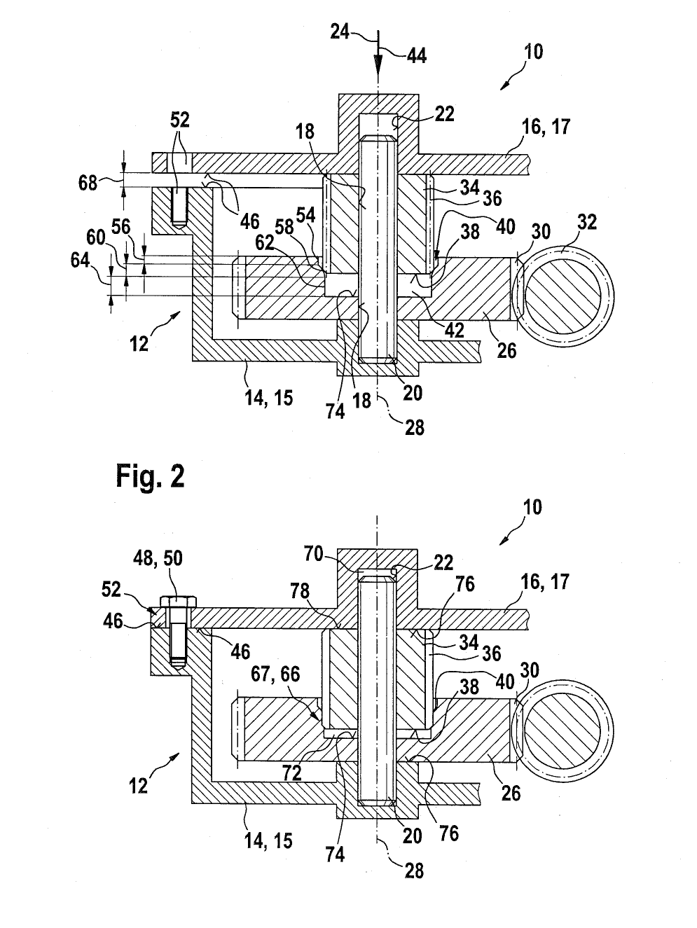

This is depicted in FIG. 2, in which the exemplary embodiment according to FIG. 1 is closed securely after final assembly. Connecting elements 48 are accommodated in corresponding connecting receptacles 52, by way of which pinion 34 is pressed into recess 42 so far that any axial play between pinion-worm gear unit 34, 26 and housing 12 is compensated, and they do not become jammed. In the fully-assembled state, gearbox 10 therefore still includes an air gap 70 between support bolt 20 and second housing part 16, and a clearance 72 between end face 38 of pinion 34 and a base surface 74 of recess 42.

In one variation, radial clearance-fitting region 54 can also be designed conical with transition region 58, as shown in FIG. 2. It is important that pinion 34 and its outer toothing 36 are pressed into interference region 62 of recess 42 so far that axial and radial displacement between pinion 34 and worm gear 26 are prevented. To this end, in FIG. 2, inner profile 40 of recess 42 is designed as a form-fit connection 67 that corresponds to outer toothing 36 and makes it possible to non-rotatably transfer high torques from worm gear 26 to pinion 34. Housing parts 14 and 16 each have an axial bearing surface 76 against which, in the fully assembled state, pinion 34 and worm gear 26 bear with their axial stop faces 78.

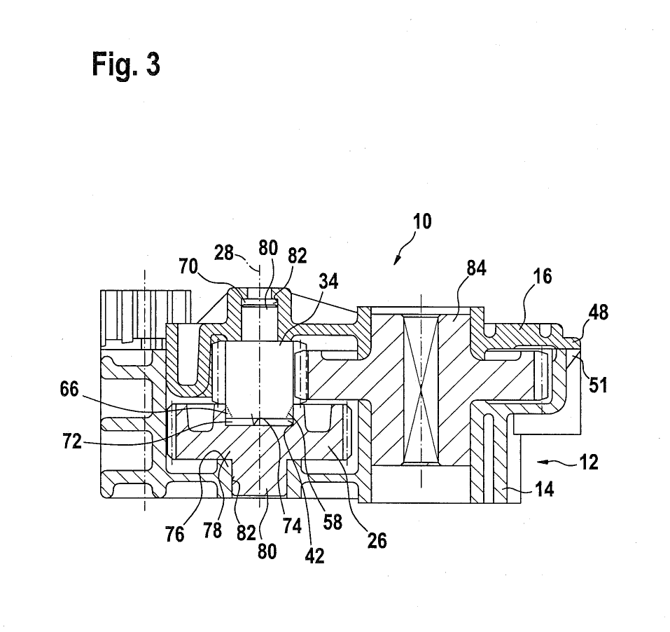

FIG. 3 shows an alternative exemplary embodiment of a gearbox 10, in the case of which housing 12 does not have a support bolt 20. Instead, pinion 34 and worm gear 26 each have an axial bearing journal 80 that engages in a corresponding journal receptacle 82 in housing 12. When housing 12 is assembled, pinion 34 and worm gear 26 are inserted into each other along with housing parts 14 and 16 along axis 28 such that end face 38 of pinion 34 is pressed securely into recess 42. The radial support of pinion-worm gear unit 34, 26 in housing 12 takes place via bearing journal 80; pinion 34 is secured against tilting relative to worm gear 26 via interference fit 66. Pinion 34 engages in a driven element 84, into which, e.g., two flexible drive shafts that serve to displace movable parts can be inserted. To connect housing parts 14 and 16, they are provided with snap-in elements 51, as connecting elements 48, which snap into place as soon as housing parts 14 and 16 are completely joined. As an alternative to conical transition region 58 of recess 42 shown in FIG. 2, in FIG. 3, a conical transition region 58 is integrally formed on pinion 34 that serves to center pinion 34 relative to worm gear 26.

It should be noted that, with regard for the exemplary embodiments presented in the figures and the description, many different combinations of the individual features are possible. For example, the radial support of worm gear 26 and pinion 34 inside housing 12 can be varied. The inventive connection between pinion 34 and worm gear 26 can be used for various gearbox types, e.g., a multistaged gearbox 10, while the number and design of the housing parts and the gearbox components are adapted to the particular application. Pinion 34 can be connected with worm gear 26 in an exclusively non-positive manner, or via a combination of a non-positive connection and a form-fit connection. To this end, the specific design of pinion 34 on end-face end 38, or inner profile 34 of recess 42 can be adapted accordingly. Pinion 34 is preferably made of a harder material, e.g., metal, which is pressed into a softer material, e.g., plastic, of worm gear 26. Inventive gearbox 10 is preferably used to displace movable parts in a motor vehicle—seat parts in particular—but it is not limited to these types of applications.

What is claimed is:

1. A method for producing a gearbox (10) with axial tolerance compensation, in particular for displacing movable parts in a motor vehicle, that includes a housing (12) that is composed of at least two housing parts (14, 16), a pinion (34), and a worm gear (26) that has a central axial recess (42), characterized by the following steps:
the worm gear (26) and the pinion (34) are located, as separate parts, on a common central axis (28) in at least one of the two housing parts (14, 16)
the two housing parts (14, 16) are joined and connected along the axis (28) such that, during axial assembly of the two housing parts (14, 16), the pinion (34) is pressed into the recess (42) of the worm gear (26) in a non-rotatable manner.

2. The method as recited in claim 1,
wherein
a support bolt (20) is located in the housing (12) along the axis (28), on which the worm gear (26) and/or the pinion (34) are radially supported.

3. The method as recited in claim 1,
wherein
each of the two housing parts (14, 16) has an axial support surface (76), against which the worm gear (26) and/or the pinion (34) bear axially after final assembly of the housing (12).

4. The method as recited in claim 1, wherein,
when the housing parts (14, 16) are joined axially, the pinion (34) is inserted first into a clearance-fitting region (54), then into a conical transition region (58), and finally into an interference region (62) of the recess (42).

5. The method as recited in claim 1,
wherein
the pinion (34) has outer toothing (36) that, when the housing parts (14, 16) are joined, engage in a matching inner profile (40) of the recess (42) to form a non-rotatable, form-fit connection (67).

6. The method as recited in claim 1,
wherein
an axial assembly force (44) required to assemble the housing parts (14, 16) axially is greater than a maximum axial force that occurs between the worm gear (26) and the pinion (34) during assembly.

7. A gearbox (10) for displacing movable parts in the motor vehicle—according to claim 1 in particular—with a housing (12) that includes a first and second housing part (14, 16) which can be connected with each other using an axial assembly force (44); a pinion (34) with an outer toothing (36) and a worm gear (26) driven by a worm (32) are located in the housing (12); the worm gear (26) includes a central axial recess (42) into which the pinion (34) engages in a non-rotatable manner,
wherein
the pinion (34) can be inserted axially into the recess (42) of the worm gear (26) using the axial assembly force (44).

8. The gearbox (10) as recited in claim 7,
wherein
a support bolt (20) is located in the housing (12), on which the worm gear (26) and/or the pinion (34) are radially supported.

9. The gearbox (10) as recited in claim 7,
wherein
the worm gear (26) and/or the pinion (34) include an axial through-bore (18) that enables them to be supported directly and radially on the support bolt (20).

10. The gearbox (10) as recited in claim 1,
wherein
the worm gear (26) and/or the pinion (34) include an axial bearing journal (80) for radial support in the housing (12).

11. The gearbox (10) as recited in claim 1,
wherein
the recess (42) and/or the pinion (34) include a conical transition region (58) and an interference region (62) with axial expansions (60, 64).

12. The gearbox (10) as recited in claim 1,
wherein
the recess (42) includes an axial base (74) that, after final assembly of the housing (12), is located such that it has axial clearance (72) from an end face (38) of the pinion (34).
